(19) United States
(12) Patent Application Publication
(10) Pub. No.: US 2026/0312639 A1
(43) Pub. Date: Oct. 8, 2026

(54) WIRELESS COMMUNICATION SYSTEM, WIRELESS COMMUNICATION DEVICE, WIRELESS COMMUNICATION METHOD, AND WIRELESS COMMUNICATION PROGRAM

(71) Applicant: NTT, Inc., Tokyo (JP)

(72) Inventors: Daisuke GOTO, Musashino-shi, Tokyo (JP); Fumihiro YAMASHITA, Musashino-shi, Tokyo (JP); Kiyohiko ITOKAWA, Musashino-shi, Tokyo (JP); Koyo TATEGAMI, Musashino-shi, Tokyo (JP)

(73) Assignee: NTT, Inc., Tokyo (JP)

(21) Appl. No.: 19/484,893

(22) PCT Filed: Jun. 1, 2023
(86) PCT No.: PCT/JP2023/020539

§ 371 Date: Nov. 17, 2025

(51) Int. Cl. H04B 7/0456; H04B 7/185

(52) U.S. Cl. CPC H04B 7/0456; H04B 7/185

(57) ABSTRACT

A transmission station including a plurality of antennas and a plurality of reception stations are included. Transmission interference compensation of performing transmission precoding on a transmission signal from the transmission station such that a signal in an interference compensated state reaches the reception station, and reception interference compensation of extracting a desired component from an interfering signal in the reception station can be selected. The transmission station and the reception station apply one of the transmission interference compensation and the reception interference compensation to each of a plurality of channels formed between antennas of the transmission station and the reception station. A function of setting a combination of a channel to which the transmission interference compensation is applied and a channel to which the reception interference compensation is applied to a different set according to a channel condition is included.

### TECHNICAL FIELD

This disclosure relates to a wireless communication system, a wireless communication device, a wireless communication method, and a wireless communication program, and more particularly, to a wireless communication system, a wireless communication device, a wireless communication method, and a wireless communication program suitable for achieving efficient MIMO transmission in an environment in which a channel status changes.

### BACKGROUND ART

Non Patent Literature 1 below proposes utilizing a multiple input multiple output (MIMO) technology when performing wireless communication between a satellite and a ground base station. In the MIMO technology, a plurality of antennas is disposed on at least one of a transmission side and a reception side, and spatial multiplexing transmission of radio signals is performed. With this technology, the communication capacity can be greatly expanded as compared with a case where wireless communication using a pair of antennas is performed between the transmission side and the reception side.

When radio signals are transmitted from a plurality of transmission antennas and received by a plurality of reception antennas, a plurality of transmission signals can reach the reception antennas in an interfering state. Therefore, in the MIMO technology executed using a plurality of antennas, an interference compensation technology for separating interference waves is necessary.

The interference compensation technology is roughly divided into transmission precoding and reception interference compensation. Non Patent Literature 2 below discloses a technology related to transmission precoding. In addition, Non Patent Literature 3 below discloses a technology related to reception interference compensation.

### CITATION LIST

### Non Patent Literature

Non Patent Literature 1: A. Knopp, R. T. Schwarz, D. Ogermann, C. A. Hofmann and B. Lankl, “Satellite System Design Examples for Maximum MIMO Spectral Efficiency in LOS Channels,” IEEE GLOBECOM 2008-2008 IEEE Global Telecommunications Conference, 2008, pp. 1-6.
Non Patent Literature 2: Stankovic, Veljko, and Martin Haardt. “Generalized design of multi-user MIMO precoding matrices.” IEEE Transactions on Wireless Communications 7.3 (2008): 953-961.
Non Patent Literature 3: Ahmed, Sajid, et al. “Iterative receivers for MIMO-OFDM and their convergence behavior.” IEEE Transactions on Vehicular Technology 58.1 (2008): 461-468.

### SUMMARY OF INVENTION

### Technical Problem

In transmission precoding, a state of a channel formed between an antenna of a transmission station and an antenna of a reception station is estimated on a transmission side in advance. Based on the estimated channel state, the transmission station transmits a precoded signal such that a transmission wave reaches the antenna on the reception side in a state in which the effect of interference is canceled. In this case, the reception station can receive and demodulate the signals reaching the respective reception antennas without considering the MIMO transmission.

Meanwhile, in a case where the transmission station is a mobile satellite or the like and the reception station is a ground base station, the state of the channel between the transmission station and the reception station changes from moment to moment. In this case, when the time when the transmission station estimates the channel state is different from the time when the transmission station sends a signal, the accuracy of interference compensation by precoding is deteriorated due to a change in channel state. As described above, the transmission precoding has an advantage that the load of the reception station can be reduced, but has a disadvantage that the amount of improvement by the compensation is limited because the compensation is completed at the time of transmission.

In a reception interference compensation technology, a transmission station transmits a transmission signal without processing the transmission signal. In this case, a plurality of signals can reach the reception station while interfering with each other. Under such circumstances, the reception station estimates a channel formed between the transmission antenna and the reception antenna based on the reception signal, and performs interference compensation for separating individual signals from the signal affected by the interference by using the estimated channel state. Here, because channel estimation is performed based on the reception signal, unlike the case of precoding, interference compensation can be performed based on a latest channel state.

In addition, a non-linear compensation technology such as all candidate search by maximum likelihood detection (MLD) or successive interference cancellation (SIC) by repetitive calculation can be applied to the reception interference compensation. For this reason, when a processing delay due to calculation can be allowed, interference compensation with sufficiently high accuracy can be achieved as compared with the case of transmission precoding.

On the other hand, the reception interference compensation has a characteristic that a processing delay tends to be large as compared with the transmission precoding. For example, when MIMO transmission is performed between a mobile station mounted on a satellite and a plurality of ground antennas, the ground antennas are usually installed at a sufficient distance from each other. In this case, the reception interference compensation is performed on the signals received by the plurality of ground antennas by collecting the signals at one place. Since the ground antennas are installed apart from each other, a certain propagation time is necessary to collect all the reception signals at one place. Then, such a propagation time becomes a factor of prolonging the processing delay. As described above, the reception interference compensation is advantageous in achieving highly accurate interference compensation, but has a disadvantage that it is likely to involve a large processing delay.

As described above, transmission precoding and reception interference compensation conventionally used as interference compensation technologies for achieving MIMO transmission both have advantages and disadvantages. For this reason, regardless of which interference compensation technology is used, it is difficult to always achieve low-delay and high-accuracy spatial multiplexing transmission under various environments.

In order to solve the above problems, a first object of the present disclosure is to provide a wireless communication system that efficiently achieves low-delay and high-accuracy spatial multiplexing transmission under various environments.

In addition, a second object of the present disclosure is to provide a wireless communication device that efficiently achieves low-delay and high-accuracy spatial multiplexing transmission under various environments.

In addition, a third object of the present disclosure is to provide a wireless communication method for efficiently achieving low-delay and high-accuracy spatial multiplexing transmission under various environments.

In addition, a fourth object of the present disclosure is to provide a wireless communication program for efficiently achieving low-delay and high-accuracy spatial multiplexing transmission under various environments.

### Solution to Problem

In order to achieve the above object, a first aspect is desirably a wireless communication system including a transmission station that includes a plurality of antennas and moves and a plurality of reception stations, and performing spatial multiplexing transmission between the transmission station and the plurality of reception stations, wherein
a function of transmission interference compensation of performing transmission precoding on a transmission signal from the transmission station such that a signal in an interference compensated state reaches the reception station, and a function of reception interference compensation of extracting a desired component from an interfering signal in the reception station can be selected, and
the transmission station and the reception station apply one of the transmission interference compensation and the reception interference compensation to each of a plurality of channels formed between antennas of the transmission station and the reception station,
the wireless communication system including:
a transmission/reception interference compensation combination function of setting a combination of a channel to which the transmission interference compensation is applied and a channel to which the reception interference compensation is applied to a different set according to a channel condition.

In addition, a second aspect is desirably a wireless communication device functioning as a transmission station including a plurality of antennas and moving and performing spatial multiplexing transmission with respect to a plurality of reception stations, the wireless communication device being configured to execute:
processing of transmission interference compensation of performing transmission precoding on a transmission signal such that a signal in an interference compensated state reaches the reception station,
processing of transmitting a transmission signal on an assumption that reception interference compensation of extracting a desired component from an interfering signal is executed by the reception station,
processing of determining a target of the transmission interference compensation such that one of the transmission interference compensation and the reception interference compensation is applied to each of a plurality of channels formed between the transmission station and the reception station, and
processing of setting a combination of a channel subject to the transmission interference compensation and a channel subject to the reception interference compensation to a different set according to a channel condition.

In addition, a third aspect is desirably a wireless communication method for performing spatial multiplexing transmission between a transmission station including a plurality of antennas and moving and a plurality of reception stations, the wireless communication method including:
enabling selection of a function of transmission interference compensation of performing transmission precoding on a transmission signal from the transmission station such that a signal in an interference compensated state reaches the reception station, and a function of reception interference compensation of extracting a desired component from an interfering signal in the reception station;
causing the transmission station and the reception station to apply one of the transmission interference compensation and the reception interference compensation to each of a plurality of channels formed between antennas of the transmission station and the reception station; and
setting a combination of a channel to which the transmission interference compensation is applied and a channel to which the reception interference compensation is applied to a different set according to a channel condition.

In addition, a fourth aspect is desirably a wireless communication program for causing a wireless communication device to function as a transmission station including a plurality of antennas and moving and performing spatial multiplexing transmission with respect to a plurality of reception stations, the wireless communication program including a computer-readable program for causing the wireless communication device to execute:
processing of transmission interference compensation of performing transmission precoding on a transmission signal such that a signal in an interference compensated state reaches the reception station,
processing of transmitting a transmission signal on an assumption that reception interference compensation of extracting a desired component from an interfering signal is executed by the reception station,
processing of determining a target of the transmission interference compensation such that one of the transmission interference compensation and the reception interference compensation is applied to each of a plurality of channels formed between the transmission station and the reception station, and
processing of setting a combination of a channel subject to the transmission interference compensation and a channel subject to the reception interference compensation to a different set according to a channel condition.

### Advantageous Effects of Invention

According to the first to fourth aspects, it is possible to efficiently achieve low-delay and high-accuracy spatial multiplexing transmission under various environments.

### BRIEF DESCRIPTION OF DRAWINGS

FIG. 1 is a diagram illustrating a configuration in a case where a wireless communication system according to a first embodiment of the present disclosure is achieved by using a satellite and a ground base station;

FIG. 2 is a diagram illustrating a generalized configuration of the first embodiment of the present disclosure by replacing the satellite illustrated in FIG. 1 with a mobile station;

FIG. 3 is a diagram for describing an overview of transmission precoding performed in the first embodiment of the present disclosure;

FIG. 4 is a diagram for describing an overview of reception interference compensation performed in the first embodiment of the present disclosure;

FIG. 5 is a diagram illustrating a state in which a first signal s₁ and a second signal s₂ are strongly correlated while a third signal s₃ is not strongly correlated with the first signal s₁ and the second signal s₂ in the first embodiment of the present disclosure;

FIG. 6 is a diagram illustrating a state in which the second signal s₂ and the third signal s₃ are strongly correlated while the first signal s₁ is not strongly correlated with the second signal s₂ and the third signal s₃ in the first embodiment of the present disclosure;

FIG. 7 is a diagram for describing the content of interference compensation adopted in the state illustrated in FIG. 5 in the first embodiment of the present disclosure;

FIG. 8 is a diagram for describing the content of interference compensation adopted in the state illustrated in FIG. 6 in the first embodiment of the present disclosure;

FIG. 9 is a block diagram for functionally describing configurations of a mobile station, a reception station, and a ground base station included in the first embodiment of the present disclosure; and

FIG. 10 is a flowchart for describing a flow of processing executed in the first embodiment of the present disclosure.

### DESCRIPTION OF EMBODIMENTS

### First Embodiment

### [Configuration of First Embodiment]

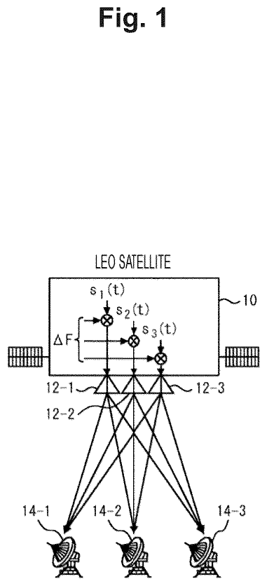

FIG. 1 illustrates a configuration in a case where a wireless communication system according to a first embodiment of the present disclosure is achieved by using a satellite and a ground base station. As illustrated in FIG. 1, the system of the present embodiment includes a satellite 10. The satellite 10 includes a plurality of antennas. FIG. 1 illustrates a state in which the satellite 10 includes three antennas 12-1 to 12-3. Hereinafter, in a case where it is not necessary to distinguish them, they are referred to as “antennas 12” by omitting reference signs of suffixes.

The system of the present embodiment also includes one or more reception stations. FIG. 1 specifically illustrates an example in which the system of the present embodiment includes three reception stations 14-1 to 14-3. Each of the reception stations 14-1 to 14-3 includes a ground antenna. Hereinafter, when it is not necessary to distinguish the reception stations 14-1 to 14-3 from each other, the reference signs of the suffixes are omitted and the reception stations are referred to as “reception stations 14”.

The satellite 10 illustrated in FIG. 1 may be a LEO satellite. The LEO satellite, for example, orbits in a low Earth orbit (LEO), which is an orbit around the Earth at an altitude of less than 2,000 km. The LEO is closer to the Earth's surface than a geostationary earth orbit (GEO). Therefore, the communication system using the LEO satellite can enjoy various advantages.

Specifically, the distance between the LEO satellite and the reception stations 14 is 1/10 or less as compared with the case of using a GEO satellite. Therefore, in the system using the LEO satellite, the propagation delay can be significantly reduced as compared with the system using the GEO satellite. In addition, since the propagation distance is small, the propagation loss is also small. Therefore, it is possible to reduce the power consumption of the transmission station, downsize the transmission station and the ground station, and the like, and it is possible to expect a reduction in equipment cost.

Note that the LEO satellite is different from the GEO satellite in that the LEO satellite is characterized by constantly moving as seen from the ground. For this reason, in order to always deploy the service using the LEO satellite, it is necessary to launch a plurality of satellites to deploy the coverage throughout the entire service area. In particular, in order to deploy a global service, it is essential to deploy a satellite constellation in earth orbit.

In addition, in a service using the LEO satellite, in a case where it is desired to increase the communication capacity of a ground terminal or in a case where the number of accommodated terminals is increased, it is also necessary to increase the capacity of the line of a feeder link for exchanging communication data between the satellite and the base station. In order to increase the capacity, it is desirable to use a high frequency band capable of performing communication in a wide band. In particular, in the field of satellite communication, utilization of the Ka band of 20 to 30 GHz band and the Q/V band of 40 to 50 GHz band has been studied. Since the effect of rain attenuation is large in these bands, it is necessary for the communication system to be constructed so as to allow the occurrence of communication interruption at the time of rain. As a countermeasure against rainfall, for example, a method of site diversity in which a plurality of antennas is remotely disposed and used has been studied.

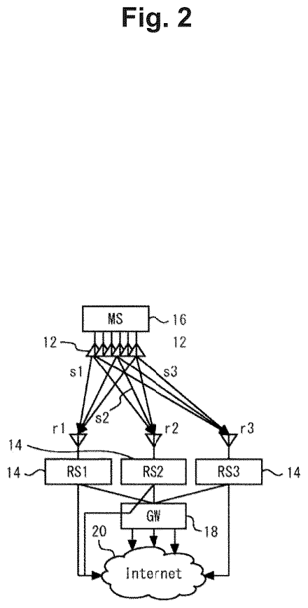

FIG. 2 illustrates a diagram illustrating a generalized configuration of the first embodiment of the present disclosure in which the satellite 10 illustrated in FIG. 1 is replaced with a mobile station (hereinafter, referred to as a moving station: “MS”) 16. The MS 16 can be any mobile station having a communication function including a high altitude platform station (HAPS) that flies at an altitude of about 20 km from the ground in addition to the above-described LEO satellite.

The MS 16 illustrated in FIG. 2 includes a plurality of antennas 12 similarly to the satellite 10 illustrated in FIG. 1. The MS 16 can individually transmit different signals from the plurality of antennas 12, respectively. FIG. 2 illustrates a state in which the antennas 12 send first signals s1, second signals s2, and third signals s3.

In the example illustrated in FIG. 2, three reception stations 14 are communicating with the MS 16. Here, the reception station 14 illustrated on the left side in the drawing is RS1, the reception station 14 illustrated in the center in the drawing is RS2, and the reception station 14 illustrated on the right side in the drawing is RS3. In addition, signals received by the RS1 are referred to as signals r1, signals received by the RS2 are referred to as r2, and signals received by the RS3 are referred to as r3. The RS1 to RS3 can transmit the reception signals r1 to r3 to the ground base station (hereinafter, referred to as a gate way: “GW”) 18, respectively. After performing processing such as decoding on the signals r1 to r3, the GW 18 can send the signals r1 to r3 to an Internet line 20.

### [Interference Compensation Used in First Embodiment]

The wireless communication system of the present embodiment achieves MIMO transmission by using the plurality of antennas 12 included in the MS 16 and the plurality of reception stations 14 connected to the GW 18. In addition, in the present embodiment, the transmission precoding and the reception interference compensation are appropriately combined and used as an interference compensation method for achieving MIMO transmission.

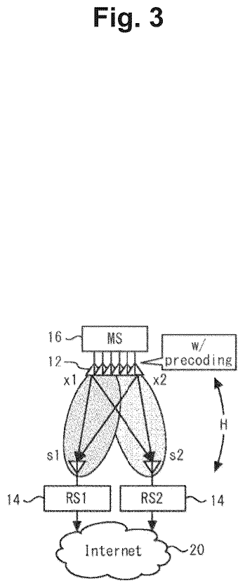

FIG. 3 illustrates a state in which the wireless communication system of the present embodiment performs transmission precoding. For convenience of description, here, two reception stations RS1 and RS2 are illustrated as the reception stations 14.

The transmission precoding is performed after the MS 16 as a transmission station grasps a channel state formed between the antennas 12 and the reception stations 14. The MS 16 grasps the channel state by, for example, the method described below.
Causing each of the plurality of reception stations 14 to send sequentially a pilot signal in time series.
The MS 16 senses in what state the signals sent from the reception stations 14 are received by the plurality of antennas 12.
Since the state of the channel is reflected in the signals received by the antennas 12, the MS 16 can grasp the channel state on the basis of these reception signals.

After grasping the channel state, the MS 16 generates a channel characteristic matrix H corresponding to the channel state. Then, transmission signals x1 and x2 generated by performing precoding using the channel characteristic matrix H on the signals s1 and s2 sent from the plurality of antennas 12 are transmitted from the individual antennas 12.

The transmission signals x1 and x2 on which the precoding described above has been performed cause the signal s1 to reach the reception station RS1 and the signal s2 to reach the reception station RS2. That is, by the precoding described above, the transmission signals s1 and s2 before being subject to the precoding can reach the respective reception stations 14. Therefore, the reception side does not need to perform interference compensation on the reception signal.

Note that the method by which the MS 16 grasps the channel state is not limited to the above method. For example, a pilot signal may be sent from the MS 16 side, and the GW 18 may grasp the channel state and notify the MS 16 of the channel state. Alternatively, the plurality of reception stations 14 may be caused to simultaneously send pilot signals by dividing the pilot signal to be sent from the reception station 14 by frequency or by configuring the pilot signals by orthogonal codes.

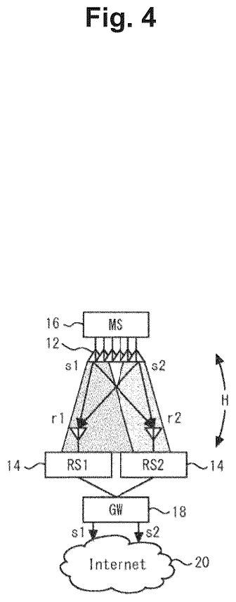

FIG. 4 illustrates a state in which the wireless communication system of the present embodiment performs reception interference compensation. For convenience of description, also here, there are only two reception stations RS1 and RS2 as the reception stations 14.

In the reception interference compensation, the MS 16, which is a transmission station, sends the transmission signals s1 and s2 that are not processed at all from the plurality of antennas 12. In this case, when interference occurs between s1 and s2 in the process of channel propagation, reception signals r1 and r2 including the component of s1 and the component of s2 reach the RS1 and the RS2, respectively. Then, the reception signals are collected in the GW 18 to separate individual components, and reception interference compensation is performed in the GW 18.

The GW 18 grasps the channel state by a method similar to the case of the MS 16 and generates a channel characteristic matrix H. Then, the effect of interference is compensated by multiplying the reception signals (r1, r2) by an inverse matrix H⁻¹ of the channel characteristic matrix H. Thereafter, the GW 18 performs processing such as demodulation on the signals and sends the signals s1 and s2 to the Internet line 20 or the like.

### [Advantages and Disadvantages of Transmission Precoding]

In the field of signal processing, it is known that a peak to average power ratio (PAPR) becomes higher as the configuration of a signal becomes uncorrelated. In addition, an amplifier generally exhibits an input/output characteristic having a distortion on the high output side. Therefore, as the PAPR of the transmission signal is larger, it is necessary to secure a larger backoff value, which is a margin with respect to the peak power. Then, as the backoff value increases, the average transmission power decreases, and it becomes difficult to increase the transmission speed of the radio signal.

In the transmission precoding, the transmission signal is processed based on the channel characteristic matrix H. When the processing is performed, the structure of the signal becomes uncorrelated. Therefore, when transmission precoding is performed, a larger backoff value is necessary than when a signal is sent without performing precoding. As a result, the transmission precoding has a disadvantage that it is difficult to ensure a high transmission speed.

In addition, in the transmission precoding method, interference compensation is completed at the time point when the signals x1 and x2 are sent. Then, the content of the interference compensation is fixed at the time point when the MS 16 grasps the channel state. On the other hand, since the MS 16 is a mobile body, the channel states do not necessarily match at the time point when the MS 16 grasps the channel state and at the time point when the MS 16 sends the signals x1 and x2. Further, the state of the channel changes due to various factors in addition to the movement of the MS 16. The transmission precoding also has a disadvantage that interference compensation performance is limited because it cannot accommodate such a change in channel state.

On the other hand, in the transmission precoding, the plurality of reception stations 14 receives the signals s1 and s2 in a state where the effect of interference is compensated. Therefore, unlike the case of reception interference compensation, it is not necessary to uniformly collect them in the GW 18. That is, by the transmission precoding, it is possible to enjoy an advantage that a signal can be transmitted with a low delay from the MS 16 to the Internet line 20 or the like existing after the RS1 and the RS2 without causing a delay for propagating a signal from the RS1 and the RS2 to the GW 18.

### [Advantages and Disadvantages of Reception Interference Compensation]

When the reception interference compensation is used as the interference compensation method, the MS 16 transmits the signals s1 and s2 without performing processing. In this case, since the PAPR at the time of transmission is suppressed and a large transmission power can be easily secured, a high transmission speed can be obtained. Further, in order to perform the reception interference compensation in a centralized manner in the GW 18, it is also possible to perform the highly accurate interference compensation by applying a non-linear compensation technology such as MLD or SIC. As described above, by the reception interference compensation, it is possible to enjoy an advantage that high-speed transmission can be performed and highly accurate wireless communication can be achieved.

On the other hand, since all the reception signals r1 and r2 are transmitted to the GW 18, occurrence of a certain propagation time cannot be avoided. In addition, if advanced non-linear compensation is to be performed, a processing delay associated therewith also occurs. Therefore, the reception interference compensation has a disadvantage that a large delay easily occurs until the transmission signals s1 and s2 from the MS 16 reach the Internet line 20 or the like.

[Suitable Interference Compensation according to Communication Environment]

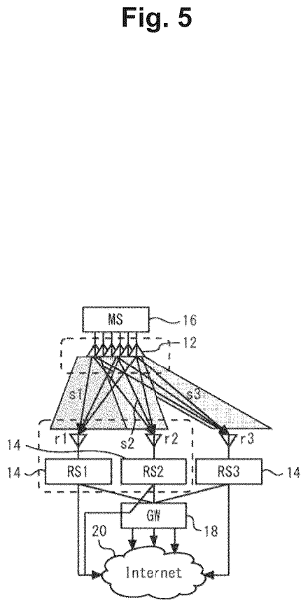

FIG. 5 illustrates an example of an environment in which the wireless communication system of the present embodiment can be placed. Here, a channel formed between the antennas 12 and the RS1 and a channel formed between the antennas 12 and the RS2 exhibit a high correlation. On the other hand, there is no substantial correlation between a channel formed between the antennas 12 and the RS3 and the other two channels.

In an environment with a high channel correlation, characteristic deterioration is likely to occur in wireless communication by the transmission precoding with limited interference compensation performance. On the other hand, a sufficiently high characteristic can be expected by the transmission precoding by linear processing such as zero forcing (ZF) or minimum mean square error (MMSE) for a channel that is not correlated with other channels. Therefore, under the environment illustrated in FIG. 5, it is desirable to perform wireless communication by reception interference compensation for which non-linear processing can be utilized for the RS1 and the RS2, and perform wireless communication by transmission precoding for the RS3.

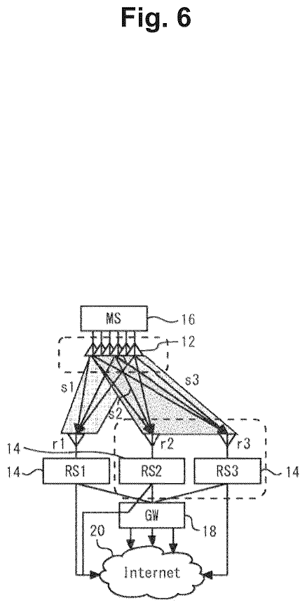

FIG. 6 illustrates a second example of an environment in which the wireless communication system of the present embodiment can be placed. The communication environment illustrated in FIG. 5 may change according to the environment illustrated in FIG. 6 as the MS 16 moves. In the environment illustrated in FIG. 6, the channel related to the RS2 and the channel related to the RS3 exhibit a high correlation. On the other hand, there is a no substantial correlation between the channel related to the RS1 and the other two channels.

Under the environment illustrated in FIG. 6, in the RS1, sufficiently high quality communication can be achieved by transmission precoding. On the other hand, for the RS2 and the RS3, it is difficult to achieve high-quality communication by transmission precoding. Therefore, in such an environment, it is desirable that communication of the RS1 is performed by transmission precoding, and communication of the RS2 and the RS3 is performed by reception interference compensation.

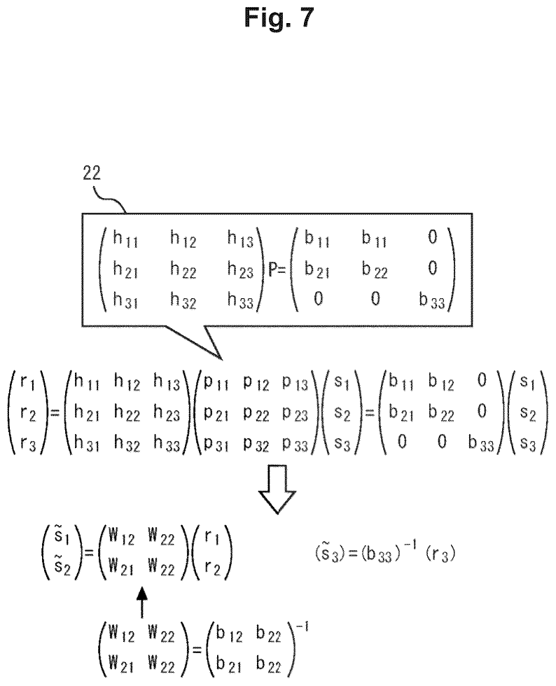

FIG. 7 is a diagram for describing a principle for achieving a suitable combination of interference compensation under the communication environment illustrated in FIG. 5. In the present embodiment, the MS 16 performs block diagonalization processing indicated by reference numeral 22 in FIG. 7 under the communication environment illustrated in FIG. 5. Specifically, a block-diagonalized matrix b is generated by multiplying the channel characteristic matrix H by a weight matrix P by the procedure described below.
(Step 1) The channels between the antennas 12-1 to 12-3 and the reception stations RS1 to RS3 are estimated.
(Step 2) A channel characteristic matrix H (h₁₁, h₁₂, . . . , h₃₂, h₃₃) is calculated based on the channel estimation result.
(Step 3) A cross-correlation situation regarding the RS1, the RS2, and the RS3 is estimated based on the channel estimation result.
(Step 4) The weight matrix P corresponding to the estimated cross-correlation situation is read. The MS 16 stores a plurality of weight matrices P corresponding to each of combinations of correlations that can occur among the three: the RS1, the RS2, and the RS3. Here, P corresponding to the result of the estimated cross-correlation is read out from these.

Under the communication environment illustrated in FIG. 5, the weight matrix P corresponding to the environment in which the channels of the RS1 and the RS2 are correlated and the channel of the RS3 is not correlated with the other two is read. The weight matrix P is determined to establish the relationship of the block diagonalization processing 22 illustrated in FIG. 7 for the channel characteristic matrix H, that is, to establish the relationship described below.

(H)·(P)=(b)

However, (b) is a matrix in which a block of (b₁₁, b₁₂, b₂₁, b₂₂) and an element of (b₃₃) are disposed diagonally.

The MS 16 performs block diagonalization precoding on the transmission signals s₁ to s₃ using the matrix (b) generated in the above procedure. In the environment illustrated in FIG. 5, precoding of multiplying the transmission signals s₁ to s₃ by the block diagonalization matrix (b) illustrated in FIG. 7 is performed, specifically. In this case, signals r₁, r₂, and r₃ reaching the RS1, the RS2, and the RS3 are as described below according to the arithmetic expression illustrated in the middle part of FIG. 7.

$${r}_{1} = {b}_{11} \cdot {s}_{1} + {b}_{12} \cdot {s}_{2}$$

$${r}_{2} = {b}_{21} \cdot {s}_{1} + {b}_{22} \cdot {s}_{2}$$

$${r}_{3} = {b}_{33} \cdot {s}_{3}$$

The signal r₃ reaching the RS3 in which no correlation of channel occurs includes only the component of the third signal s₃. For this reason, reception interference compensation is not necessary for r₃. As illustrated on the right side of the lower part of FIG. 7, the reception station RS3 can restore a transmission signal s₃~ only by multiplying the reception signal r₃ by an inverse function (b₃₃)⁻¹ of (b₃₃).

On the other hand, both the signal r₁ reaching the RS1 and the signal r₂ reaching the RS2 include the component of the first signal s₁ and the component of the second signal s₂. Therefore, it is necessary to perform reception interference compensation on these signals in the GW 18. In this case, as illustrated on the left side of the lower part of FIG. 7, the GW 18 can restore transmission signals s₁~ and s₂~ by multiplying the reception signal (r₁, r₂) by weight w=(w₁₁, w₁₂, w₂₁, w₂₂) including an inverse function (b)⁻¹ of the matrix (b).

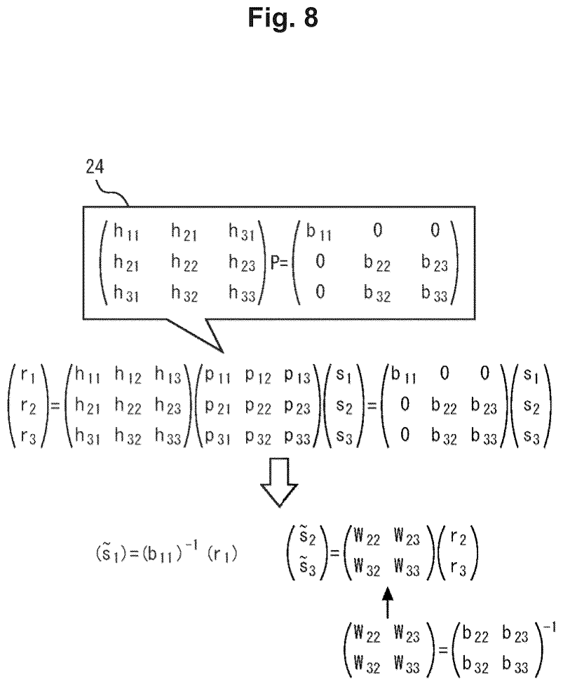

FIG. 8 is a diagram for describing a principle for achieving a suitable combination of interference compensation under the communication environment illustrated in FIG. 6. The MS 16 of the present embodiment performs block diagonalization processing indicated by reference numeral 24 in FIG. 8 under the communication environment illustrated in FIG. 6. Specifically, a block-diagonalized matrix b corresponding to the communication environment of FIG. 6 is generated by a procedure similar to that in the case described with reference to FIG. 7.

Specifically, first, a weight matrix P that establishes a relationship of the block diagonalization processing 24 illustrated in FIG. 8 is read out as one corresponding to the communication environment in which the channels of the RS2 and the RS3 are correlated and the channel of the RS1 is not correlated with the other two. The weight matrix P is determined to establish the relationship described below for the channel characteristic matrix H.

$$( H ) \cdot ( P ) = ( b )$$

However, (b) is a matrix in which an element of (b₁₁) and a block of (b₂₂, b₂₃, b₃₂, b₃₃) are disposed diagonally.

The MS 16 performs block diagonalization precoding on the transmission signals s₁ to s₃ using the matrix (b) described above. In this case, signals r₁, r₂, and r₃ reaching the RS1, the RS2, and the RS3 are as described below according to the arithmetic expression illustrated in the middle part of FIG. 8.

$${r}_{1} = {b}_{11} \cdot {s}_{1}$$

$${r}_{2} = {b}_{22} \cdot {s}_{2} + {b}_{23} \cdot {s}_{3}$$

$${r}_{3} = {b}_{32} \cdot {s}_{2} + {b}_{33} \cdot {s}_{3}$$

The signal r₁ reaching the RS3 in which no correlation of channel occurs includes only the component of the first signal s₁. For this reason, reception interference compensation is not necessary for r₁. As illustrated on the left side of the lower part of FIG. 8, the reception station RS1 can restore a transmission signal s₁~ only by multiplying the reception signal r1 by an inverse function (b₁₁)⁻¹ of (b₁₁).

On the other hand, both the signal r₂ reaching the RS2 and the signal r₃ reaching the RS3 include the component of the second signal s₂ and the component of the third signal s₃. Therefore, it is necessary to perform reception interference compensation on these signals in the GW 18. In this case, as illustrated on the right side of the lower part of FIG. 8, the GW 18 can restore transmission signals s₂~ and s₃~ by multiplying the reception signal (r₂, r₃) by weight w=(w₂₂, w₂₃, w₃₂, w₃₃) including an inverse function (b)⁻¹ of the matrix (b).

### [Functional Configuration of Wireless Communication System]

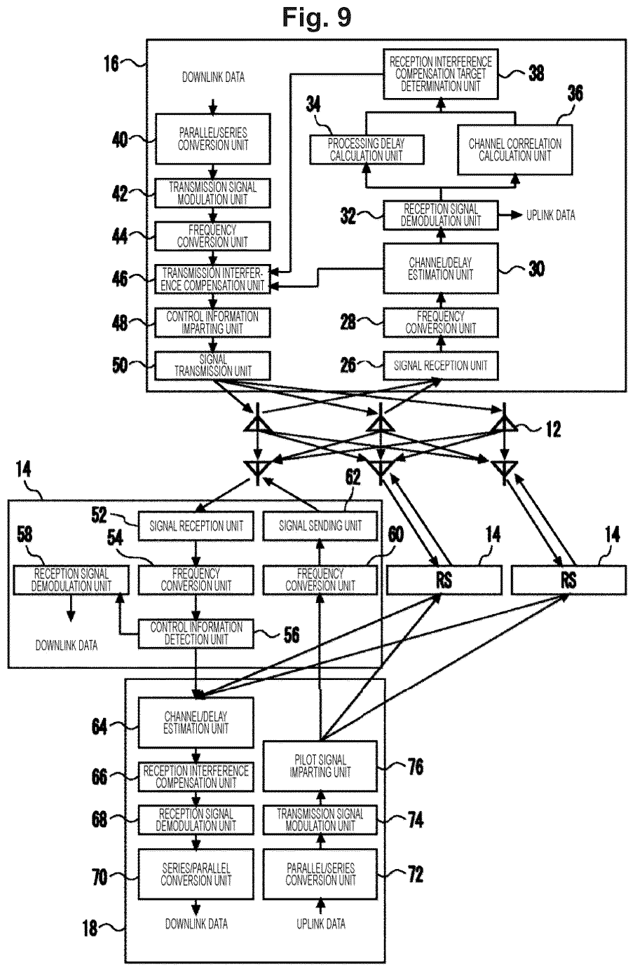

FIG. 9 is a block diagram for functionally describing the configurations of the RS 14, the MS 16, and the GW 18. Specifically, the configuration illustrated in FIG. 9 can be achieved by a combination of dedicated hardware and components of a computer system. The computer system includes a processor represented by a CPU, a memory device including ROM, RAM, a hard disk, and the like, and various interface devices. The functions of the RS 14, the MS 16, and the GW 18 are achieved by executing programs stored in the respective memory devices by the respective processors.

As illustrated in FIG. 9, the MS 16 has the blocks described below to process downlink data to be transmitted toward the RS 14.

“Parallel/series conversion unit 40”: A block that performs parallel/series conversion on bit information of downlink data. The number of parallel is set to the number of connections of a communication target that is the transmission source of the downlink data. It is assumed that the number of connections is provided to the MS 16 as control information.

“Transmission signal modulation unit 42”: A block that modulates a bit string and converts the bit string into an electrical signal.

“Frequency conversion unit 44”: A block that converts an electrical signal into a predetermined frequency to be given to a radio signal sent from the antenna 12.

“Transmission interference compensation unit 46”: A block that performs transmission precoding on a transmission signal.

“Control information imparting unit 48”: A block for imparting, to a transmission signal, selection information of transmission/reception interference compensation determined by a reception interference compensation target determination unit 38 to be described below.

“Signal transmission unit 50”: A block for transmitting a transmission signal from the antenna 12.

The MS 16 has the blocks described below to process uplink data transmitted from the GW 18.

“Signal reception unit 26”: A block for receiving a signal reaching the antenna 12.

“Frequency conversion unit 28”: A block that converts a radio signal received by the antenna 12 into an electrical signal of a predetermined frequency.

“Channel/delay estimation unit 30”: A block that estimates the state of a channel formed between the antenna 12 of the MS 16 and the reception station 14 based on a signal received by the signal reception unit 26. The estimated channel state is provided to the transmission interference compensation unit 46. In addition, in this block, a delay time when the reception station 14 aggregates the reception signal to the GW 18 is estimated.

“Reception signal demodulation unit 32”: A block that demodulates an electrical signal into a bit string.

“Processing delay calculation unit 34”: A block for calculating a time of a processing delay caused when the GW 18 performs reception interference compensation on a transmission signal.

“Channel correlation calculation unit 36”: A block for calculating, on the basis of a channel state, what correlation exists between channels heading for each of the RSs 14 in a state of communication with the MS 16 and other channels.

“Reception interference compensation target determination unit 38”: A block that selects a reception station 14 to be subject to reception interference compensation on the basis of a channel correlation and the processing delay described above. Here, the reception station 14 using a channel having a high correlation with other channels is determined as a target of reception interference compensation. However, the reception interference compensation target may be limited to a reception station 14 in which a processing delay associated with the execution of the reception interference compensation can be suppressed to a threshold or less among the reception stations 14 recognized to use a channel having a high correlation. The reception station 14 that has not been determined to be a target of reception interference compensation is treated as a target of interference compensation only by transmission precoding.

The RS 14 has the blocks described below to process downlink data transmitted from the MS 16.

“Signal reception unit 52”: A block for receiving a signal reaching the reception station 14.

“Frequency conversion unit 54”: A block that converts a radio signal received by the antenna of the RS 14 into an electrical signal of a predetermined frequency.

“Control information detection unit 56”: A block that detects control information included in a reception signal, more specifically, selection information of transmission/reception interference included in the control information. The RS 14 determines whether or not itself is subject to reception interference compensation on the basis of the selection information read here.

“Reception signal demodulation unit 58”: A block that performs demodulation processing on a reception signal when it is determined that itself is not subject to reception interference compensation. In this case, a signal that is not affected by interference should have reached the RS 14. Therefore, the reception signal demodulation unit 58 can deliver the downlink data to the Internet line 20 or the like only by performing simple processing such as demodulation.

The RS 14 has the blocks described below to process uplink data received from the GW 18.

“Frequency conversion unit 60”: A block that converts uplink data received as an electrical signal into a predetermined frequency to be possessed by a radio signal to be sent to the MS 16.

“Signal sending unit 62”: A block for sending uplink data converted into a predetermined frequency from the antenna of the RS 14 to the MS 16.

The GW 18 has the blocks described below to process downlink data received from the RS 14.

“Channel/delay estimation unit 64”: A block for estimating the state of a channel and a delay time when the reception signal is aggregated into the GW 18, similarly to those included in the MS 16.

“Reception interference compensation unit 66”: A block for performing interference compensation in a case where reception interference compensation is necessary.

“Reception signal demodulation unit 68”: A block for demodulating an electrical signal into a bit string.

“Series/parallel conversion unit 70”: A block that generates downlink data by performing series/parallel conversion on an electrical signal demodulated into a bit string. The number of parallel is set to the number of connections of a communication target that is the transmission destination of the downlink data. The number of connections is provided to the GW 18 as control information.

The GW 18 has the blocks described below to provide the RS 14 with uplink data.

“Parallel/series conversion unit 72”: A block that performs parallel/series conversion on bit information of uplink data. The number of parallel is set to the number of connections of a communication target that is the transmission source of the uplink data. The number of connections is provided to the GW 18 as control information.

“Transmission signal modulation unit 74”: A block that modulates a bit string and converts the bit string into an electrical signal.

“Pilot signal imparting unit 76”: A block that imparts a pilot signal for channel estimation to a transmission signal.

### Operation of First Embodiment

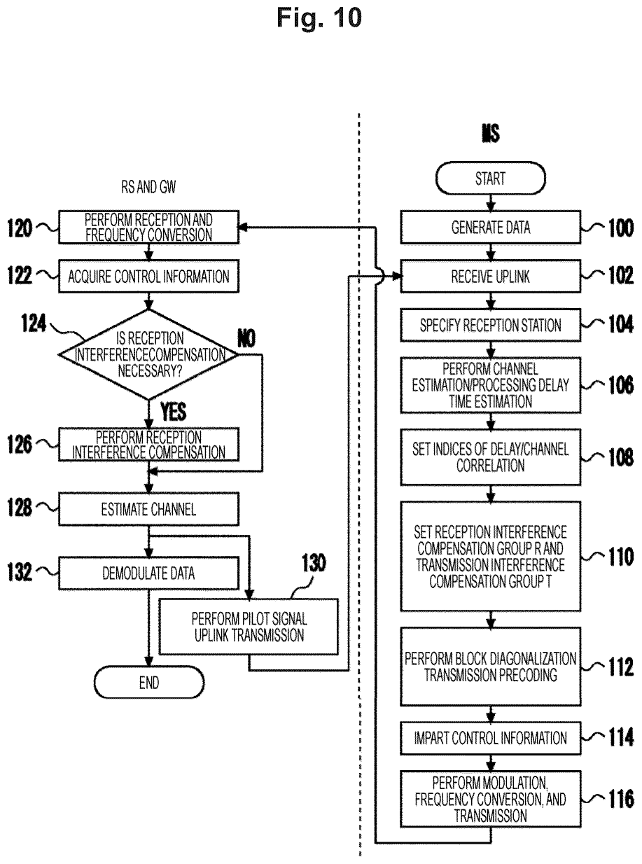

FIG. 10 is a flowchart for describing a flow of processing executed in each of the MS 16 functioning as a transmission station and the RS 14 and the GW 18 disposed on the reception side in the present embodiment in order to achieve the above-described functions.

When downlink data to be transmitted toward the RS 14 occurs (step 100), the MS 16, which is a transmission station, receives an uplink signal transmitted from the RS 14 (step 102). The uplink signal includes a pilot signal for performing channel estimation. Note that, in the present embodiment, it is assumed that the RS 14 periodically and repeatedly sends an uplink signal including a pilot signal to the MS 16.

Next, the MS 16 specifies the RS 14 which should be the transmission destination of the downlink data of this time (step 104). The RS 14 as the transmission destination can be specified on the basis of, for example, header information of downlink data.

Next, channel estimation and processing delay time estimation are performed (step 106). The channel estimation is performed based on the pilot signal acquired in step 102. The processing delay time is a time generated by performing reception interference compensation on the downlink data in the GW 18. This time is a sum of a propagation time of data from the RS 14 to the GW 18 and a time required for the GW 18 to complete reception interference compensation. When the RS 14 which should be the transmission destination is determined, the former propagation time can be calculated on the basis of its position. The latter required time is determined in advance.

Following the above processing, indices for processing delay and channel correlation are set (step 108). These indices are used to determine whether interference compensation on the current downlink data is performed by transmission precoding or by reception interference compensation. That is, in the present embodiment, when the RS 14 having a small processing delay associated with the execution of the reception interference compensation and a high channel correlation is the transmission destination, the RS 14 is set as a target of the reception interference compensation. Here, a threshold necessary for performing this determination is set as the above indices.

Next, the RS 14 as the current transmission destination is classified into one of a group R of reception interference compensation and a group T of transmission interference compensation according to the above determination criterion (step 110). Specifically, the RS 14 having a small processing delay and a high channel correlation is classified into the group R of reception interference compensation. On the other hand, the RS 14 in which a large processing delay occurs and the RS 14 having a low channel correlation are classified into the transmission interference compensation group T. However, the grouping rule is not limited thereto. For example, the RS 14 having a high channel correlation may be classified into the group R of reception interference compensation, and the RS 14 having a low channel correlation may be classified into the group T of transmission interference compensation.

In the MS 16, block diagonalization precoding is then performed (step 112). Here, first, the state of cross-correlation is estimated for all the channels formed between the MS 16 and the plurality of RSs 14 on the basis of the state of the channel estimated in the processing of step 106 described above. Next, the weight matrix P corresponding to the estimated cross-correlation combination is read. Then, a block diagonalization matrix (b) is generated by multiplying the channel characteristic matrix H representing the state of channel by the weight matrix P.

When the above processing is completed, control information is imparted to the downlink data (step 114). The control information includes information indicating whether the RS 14 as the transmission destination belongs to the reception interference compensation group R or the transmission interference compensation group T.

Thereafter, the MS 16 transmits downlink data through processing such as modulation and frequency conversion (step 116).

The left side of FIG. 10 illustrates a flow of processing performed by the RS 14 and the GW 18. Here, first, the RS 14 receives a radio signal transmitted from the MS 16 and determines whether or not itself is a signal transmission destination. Then, if the RS 14 itself is the transmission destination, the RS 14 advances processing such as frequency conversion (step 120).

After receiving the downlink data, the RS 14 then reads a control signal included in the reception signal (step 122). As described above, the control information includes information indicating the distinction between the reception interference compensation group R and the transmission interference compensation group T.

Next, the RS 14 determines whether or not the current reception signal requires reception interference compensation on the basis of the above information (step 124). As a result, when it is determined that the reception interference compensation is unnecessary, it can be determined that the transmission precoding is performed on the currently received signal. That is, it can be determined that the currently received signal is a signal on which interference compensation has already been performed. In this case, step 126 is jumped, and then the processing of step 128 described below is executed.

On the other hand, when it is determined in step 124 described above that reception interference compensation is necessary, reception interference compensation is performed on the reception signal (step 126). Specifically, first, the reception signal is transmitted to the GW 18. In the GW 18, reception signals are collected from all the RSs 14. Then, in the GW 18, reception interference compensation for eliminating the effect of interference is performed.

As described with reference to FIGS. 7 and 8, reception interference compensation can be performed by using an inverse matrix of a block portion included in the block diagonalization matrix (b). For example, reception interference compensation can be performed by using an inverse matrix (w₁₁, w₁₂, w₂₁, w₂₂) of (b₁₁, b₁₂, b₂₁, b₂₂) in the case illustrated in FIG. 7, and by using an inverse matrix (w₂₂, w₂₃, w₃₂, w₃₃) of (b₂₂, b₂₃, b₃₂, b₃₃) in the case illustrated in FIG. 8. For example, the MS 16 may include the information of an inverse matrix w in the control information and notify the GW 18 of the information.

When the above processing ends, the GW 18 performs channel estimation based on the current reception signal (step 128). Specifically, when step 126 described above is jumped, the channel estimation is performed based on the reception signal in a state where the transmission precoding has been applied. In addition, in a case where the processing of step 126 described above is performed, channel estimation based on a signal on which reception interference compensation has been performed is performed.

Thereafter, the GW 18 performs processing of uplink transmission of the pilot signal via the RS 14 (step 130). Further, the GW 18 performs processing of demodulating the reception signal and outputting the signal to the Internet line 20 or the like (step 132).

As described above, in the present embodiment, the plurality of RSs 14 is classified into one that can achieve sufficiently highly accurate wireless communication by transmission precoding and one that requires reception interference compensation in order to achieve highly accurate communication. Then, the MS 16 performs the block diagonalization precoding, thereby transmitting the signal subject to the transmission precoding to the former RS 14 and the signal assumed to be subject to the reception interference compensation to the latter RS 14. Further, the RS 14 and the GW 18 identify classification of the reception signal and perform reception interference compensation only when necessary. Therefore, according to the present embodiment, it is possible to efficiently achieve low-delay and high-accuracy spatial multiplexing transmission at all times under various environments that occur according to movement of the MS 16.

### Second Embodiment

Next, a second embodiment of the present disclosure will be described. A wireless communication system of the present embodiment can be achieved by a hardware configuration as in the case of the first embodiment. Hereinafter, the description will be given focusing on the difference between the wireless communication system of the present embodiment and the system of the first embodiment.

In the wireless communication system of the present embodiment, reception interference compensation is performed in a GW 18 similarly to the case of the first embodiment. Therefore, in order to perform reception interference compensation, it is necessary to transmit reception signals from all RSs 14 to the GW 18. The time required for signal propagation is affected by the distance between the RS 14 and the GW 18, and thus has a different length for each RS 14. Therefore, in a reception equalizing circuit included in the GW 18 to perform reception interference compensation, buffering for accommodating a delay difference is necessary.

Meanwhile, in a case where a delay exceeding the buffer size of the GW 18 occurs, reception interference compensation cannot be performed for some RSs 14. In this case, if reception interference compensation is selected as the interference compensation method, it is obvious that the reception side cannot appropriately process the signal.

Therefore, in the present embodiment, in order to determine whether or not to classify the RS 14 determined as the transmission destination into a reception interference compensation group R, the processing described below is performed.
The delay time associated with the propagation of the reception signal is estimated in advance for each RS 14.
In step 110 illustrated in FIG. 10, it is determined whether or not the delay time associated with the propagation falls within the buffer size of the GW 18 for the RS 14 determined to use a channel having a high correlation.
As a result, when it is determined that the delay time exceeds the buffer size, the RS 14 is classified into not the reception interference compensation group R, but a transmission interference compensation group T.

By the above processing, it is possible to unfailingly avoid a signal for which the GW 18 cannot perform reception interference compensation due to a buffer size problem from being subject to reception interference compensation. Therefore, with the wireless communication system of the present embodiment, it is possible to achieve wireless communication with higher quality than the system of the first embodiment.

### Modification of First and Second Embodiments

Meanwhile, in the first and second embodiments described above, the LEO satellite and the HAPS are exemplified as the MS 16, but the MS 16 is not limited thereto. As long as the processing capability is involved, a wireless communication device that moves on the ground, such as a mobile terminal, may be used as the MS 16.

In addition, in the first and second embodiments described above, all the RSs 14 can be subject to the reception interference compensation, but the present disclosure is not limited thereto, and the RSs 14 may include those that do not support reception interference compensation. In this case, the MS 16 performs block diagonalization precoding so as not to include the RS 14 that does not support reception interference compensation in the reception interference compensation group R.

### REFERENCE SIGNS LIST

10 Satellite
12, 12-1 to 12-3 Antenna
14, 14-1 to 14-3 Reception station (RS)
16 Mobile station (MS)
18 Ground station (GW)
20 Internet line
22, 24 Block diagonalization processing

1. A wireless communication system comprising a transmission station that moves while including a plurality of antennas as well as a plurality of reception stations, and performing spatial multiplexing transmission between the transmission station and the plurality of reception stations, wherein
transmission interference compensation of performing transmission precoding on a transmission signal from the transmission station such that a signal in an interference compensated state reaches the reception station, and reception interference compensation of extracting a desired component from an interfering signal in the reception station can be selected, and
the transmission station and the reception station apply one of the transmission interference compensation and the reception interference compensation to each of a plurality of channels formed between antennas of the transmission station and the reception station,
the wireless communication system is configured to execute:
setting a transmission/reception interference compensation combination for setting a combination of a channel to which the transmission interference compensation is applied and a channel to which the reception interference compensation is applied to a different set according to a channel condition.

2. The wireless communication system according to claim 1, wherein said spatial multiplexing transmission is performed by:
the setting of the transmission/reception interference compensation combination including the transmission station applying block diagonalization precoding to a plurality of transmission signals transmitted from the plurality of antennas,
the block diagonalization precoding including weighting the plurality of transmission signals so that the transmission precoding is performed only on a channel to which the transmission interference compensation is applied, and
the reception station configured to perform the reception interference compensation on a reception signal obtained from a channel to which the reception interference compensation is applied based on channel information acquired at a time of reception.

3. The wireless communication system according to claim 2, wherein
the plurality of reception stations includes a reception station supporting the reception interference compensation and a reception station not supporting the reception interference compensation, and
the block diagonalization precoding is performed such that the transmission precoding is applied to the reception station not supporting the reception interference compensation, and the reception interference compensation is applied only to a reception station selected from among reception stations supporting the reception interference compensation.

4. The wireless communication system according to claim 2, wherein
the setting of the transmission/reception interference compensation combination includes determining the combination based on an index of communication quality, and said combination is determined such that a channel whose communication quality is improved by applying the reception interference compensation is subject to the reception interference compensation, and
the block diagonalization precoding is executed according to the determination.

5. The wireless communication system according to claim 4, wherein
the index of the communication quality is set by channel correlation, and
the combination is determined such that a channel whose correlation with another channel exceeds a threshold is subject to the reception interference compensation and a channel whose correlation with another channel is equal to or less than the threshold is subject to the transmission precoding.

6. A wireless communication device functioning as a transmission station that moves while including a plurality of antennas and performing spatial multiplexing transmission with respect to a plurality of reception stations, the wireless communication device being configured to execute:
transmission interference compensation of performing transmission precoding on a transmission signal such that a signal in an interference compensated state reaches the reception station,
transmitting a transmission signal on an assumption that reception interference compensation of extracting a desired component from an interfering signal is executed by the reception station,
determining a target of the transmission interference compensation such that one of the transmission interference compensation and the reception interference compensation is applied to each of a plurality of channels formed between the transmission station and the reception station, and
setting a combination of a channel subject to the transmission interference compensation and a channel subject to the reception interference compensation to a different set according to a channel condition.

7. A wireless communication method for performing spatial multiplexing transmission between a transmission station that moves while including a plurality of antennas and a plurality of reception stations, the wireless communication method comprising:
enabling selection of transmission interference compensation of performing transmission precoding on a transmission signal from the transmission station such that a signal in an interference compensated state reaches the reception station, and reception interference compensation of extracting a desired component from an interfering signal in the reception station;
causing the transmission station and the reception station to apply one of the transmission interference compensation and the reception interference compensation to each of a plurality of channels formed between antennas of the transmission station and the reception station; and
setting a combination of a channel to which the transmission interference compensation is applied and a channel to which the reception interference compensation is applied to a different set according to a channel condition.

8. A storage medium storing a wireless communication program for causing a wireless communication device functioning as a transmission station that moves while including a plurality of antennas and performing spatial multiplexing transmission with respect to a plurality of reception stations, wherein
the wireless communication program includes a computer-readable program for causing the wireless communication device to operate as described in claim 6.
